(19) United States
(12) Patent Application Publication
(10) Pub. No.: US 2019/0082318 A1
(43) Pub. Date: Mar. 14, 2019

(54) MOBILE EQUIPMENT IDENTITY PRIVACY, NETWORK NODE AND METHODS THEREOF

(71) Applicant: HUAWEI TECHNOLOGIES CO., LTD., Shenzhen (CN)

(72) Inventors: Philip GINZBOORG, Helsinki (FI); Valtteri NIEMI, Kista (SE)

(21) Appl. No.: 16/184,718

(22) Filed: Nov. 8, 2018

Related U.S. Application Data
(63) Continuation of application No. PCT/EP2016/060262, filed on May 9, 2016.

(51) Int. Cl. H04W 12/02; H04W 12/10; H04W 12/04; H04L 9/08

(52) U.S. Cl. CPC H04W 12/02; H04W 12/10; H04W 12/04; H04L 9/0869; H04L 9/0819; H04L 9/0866; H04L 9/0861

(57) ABSTRACT

The present disclosure describes example mobile equipment, network nodes, and related methods. One example mobile equipment comprises a transceiver configured to receive at least one encoded temporary identifier and obtain a confidentiality key and an integrity key. At least one processor of the mobile equipment is configured to derive a privacy key for the mobile equipment based on the confidentiality key and the integrity key, and then derive at least one temporary identifier based on the privacy key.

### CROSS-REFERENCE TO RELATED APPLICATIONS

This application is a continuation of International Application No. PCT/EP2016/060262, filed on May 9, 2016. The disclosure of the aforementioned application is hereby incorporated by reference in its entirety.

### TECHNICAL FIELD

The invention relates to a mobile equipment and a network node. Furthermore, the invention also relates to corresponding methods, a user device comprising such a mobile equipment, a computer program, and a computer program product.

### BACKGROUND

The present technical field relates to identity and location privacy of mobile users in wireless communication system, such as cellular networks.

The network to which the mobile device connects is called the “serving network” and the network where the mobile user has a subscription is called the “home network.” The serving network is called “visited network” when the mobile user roams outside the coverage of the home network of the mobile user. Otherwise, the serving network is the same as the home network such as in the non-roaming case. The User Equipment (UE) is the mobile user's mobile device in 3GPP parlance. The UE typically comprises a Mobile Equipment (ME), i.e. the mobile device, and Universal Integrated Circuit Card (UICC), that is the smart card with mobile user's subscription information.

The ME is the terminal device, typically a smart phone, and contains the radio interface functionality, the stack of network protocols and the user interface. The Universal Subscriber Identity Module (USIM) is an application that runs inside a UICC. The operator-dependent data about the subscriber is stored in the USIM. This data includes International Mobile Subscriber identity (IMSI), which is the long-term identity of the subscriber; and the subscriber's master key K, which is shared with the home network. The UE-internal interface between ME and USIM is defined in 3GPP TS 31.101 “UICC-Terminal interface: Physical and logical characteristics”.

The master key K is not given to the serving network. In order to protect the communication between the UE and the serving network, the home network and the UE both derive the Access Security Management Entity (ASME) key KASME. That key, KASME, is sent from the home network to the serving network.

The USIM derives a Ciphering Key (CK) and an Integrity Key (IK) and gives them to the ME. A cryptographic Key Derivation Function (KDF) is used to derive the ASME key KASME from CK, IK and the Serving Network Identity (SN ID). The SN ID typically comprises the Mobile Country Code (MCC) and Mobile Network Code (MNC) of the serving network. All cryptographic keys that are needed for various security mechanisms between the UE and the serving network are then derived from the ASME key KASME. The KDF has the property that it is impossible in practice to compute its inputs from the output ASME key KASME. The LTE KDFs use the generic KDF that is specified in 3GPP TS 33.220. In this generic KDF the core cryptographic primitive is the HMAC-SHA-256 algorithm (Keyed-Hash Message Authentication Code-Secure Hash Algorithm).

The possibility of tracking mobile users by listening to the common control channels was well understood in the design phase of GSM (during 1980s). Therefore, a mechanism was created where a temporary identity, i.e. Temporary Mobile Subscriber Identity (TMSI), is used instead of the permanent identity, i.e. the International Mobile Subscriber Identity (IMSI), for the purposes of identifying and addressing the mobile user. Once an encrypted dedicated channel is established between a particular mobile user and the network, it is possible for the network to update the pseudonym TMSI in a secure manner. If no temporary identity exists, identification of the mobile user has to be based on the permanent identity, i.e. the IMSI. This happens, for instance, in situations where a mobile user is roaming to another country and switches the mobile device on after a long flight. Another example is an error situation where the temporary identity is somehow lost either on the mobile user side or on the network side, or if the two temporary identities are not equal anymore.

An active attacker could utilize this possibility and masquerade as the genuine network, pretending to have lost the temporary identity and asking for the permanent identity from the mobile user. This kind of attacker is called an “IMSI catcher” and actual attacks of this type have been observed in several countries. It is to be noted that the term “IMSI catcher” is sometimes used in a wider meaning, referring to extended attacks, including “man-in-the-middle” type of attacks. However, we consider “IMSI catchers” in the narrower meaning where the purpose of the attack is to “catch the IMSI,” that is to obtain the long-term identifier of the mobile user.

The same mechanism that protects against passive attackers who try to break identity and location privacy in GSM has been included also in the major upgrades to the cellular networks technology: the third generation (3G) and the fourth generation (4G, or LTE, i.e. Long Term Evolution) networks. However, none of these technologies provides protection against active attackers.

One of the cornerstones in the 3G security architecture is mutual authentication that is provided by the 3GPP Authentication and Key Agreement (AKA) procedure, i.e. 3GPP TS 33.102, 3G security, and Security architecture, v. 12.2.0.

The 3GPP report TR 33.821, created during the design of 4G security, considers how to protect user identity privacy from outsider attackers. The idea in the Enhanced User Identity Confidentiality feature outlined in TR 33.821 is that cellular AKA principles will be followed, with the enhancement that IMSI is not sent as cleartext on radio interface between the UE and the serving network.

TR 33.821 outlines two main solution types for enhanced user identity confidentiality: public key-based approach and pseudonyms-based approach. The public key-based approach needs support infrastructure for public key distribution and additional crypto-elements in the home network servers. The pseudonym-based approach requires keeping synchronized state in a large distributed system. Neither solution was adopted to LTE because they were not considered “lightweight” enough. TR 33.821 does not go into the question of what to do when UE having user identity privacy enhanced visits a legacy network.

With the public-key based approach the IMSI is always sent encrypted on the radio interface, and decrypted in the home network. The encryption/decryption operations are based on asymmetric cryptography: the UE sends its IMSI encrypted with the public key of the home network, together with the identity of the home network to the serving network over the radio interface. The serving network forwards the ciphertext to the home network, and the home network decrypts the IMSI using the home network's private key. The load created on the home network servers by the decryptions depends on the choice of the public key cryptosystem together with its configuration (e.g. the key size), and the amount of traffic towards home network servers.

Note that the encryption/decryption operations could be also based on symmetric cryptography. A solution of this type that was considered in 3GPP during 3G standardization: a group of mobile users have a symmetric key that is shared with other members of the group and with the home network. The mobile users would use the symmetric key to encrypt their IMSIs when sending the IMSIs to the visited network. In the roaming case, the mobile device would only need to reveal the identity of its home operator and the identity of the group to the visited network. By this information, the visited network would be able to forward the encrypted IMSI to the correct home operator and the home operator would be able to decrypt it with the correct key. After this, the IMSI would be sent to the visited network, together with authentication data that is needed for running the AKA procedure.

With a generic pseudonyms-based approach a second layer of temporary identities/pseudonyms (in addition to TMSI/Globally Unique Temporary Identity (GUTI) that is already used since GSM) is added into the system. The UE sends a pseudonym P, rather than IMSI, together with the identity of the home network to the serving network over the radio interface. The serving network forwards the pseudonym P to the home network. The home network uses the pseudonym P to identify the UE. The “IMSI catcher” could in this case only get temporary identity, i.e. pseudonym P.

In one conventional solution, which is a variant of pseudonym-based approach, the pseudonym P has the same format as IMSI, i.e. there is a non-changing part (pointing to the correct home network) and the changing part that is in the form of Mobile Subscriber Identity Number (MSIN). Thus, the length of the changing part is 9-10 decimal digits, which can be encoded in less than 40 bits. Further, the derivation of new pseudonyms is done by USIM application inside UICC (smart card). The advantage of this conventional solution is that the pseudonym looks like a normal IMSI. Messages on the radio interface and the service network to home network interface look the same as in legacy networks to the serving network and the ME. For that reason the design would work with legacy 3G/4G serving networks and legacy ME. An IMSI catcher masquerading as a legacy network would just catch a temporary pseudonym, not the real IMSI.

However, the mentioned conventional solution has at least the weaknesses of requiring new USIM to derive new pseudonyms. When the next, fifth generation (5G) mobile network will be deployed, a new ME is likely to be required to use that network. For that reason, the combination of a new USIM and legacy ME is not very important in 5G. On the other hand, 5G ME that has a legacy 4G USIM is a likely scenario in 5G.

### SUMMARY

An objective of embodiments of the invention is to provide a solution which mitigates or solves the drawbacks and problems of conventional solutions.

Another objective of embodiments of the invention is to provide a more secure solution compared to conventional solutions.

The above objective and further objectives are achieved by the subject matter of the independent claims. Further advantageous implementation forms of the invention are defined by the dependent claims.

According to a first aspect of the invention, the above mentioned and other objectives are achieved with a mobile equipment for a wireless communication system, the mobile equipment comprising a transceiver configured to

receive at least one encoded temporary identifier,
obtain a confidentiality key and an integrity key,
a processor configured to
derive a privacy key for the mobile equipment based on the confidentiality key and the integrity key,
derive at least one temporary identifier based on the privacy key.

Typically, in a new generation of mobile networks the radio interface changes so much that it cannot be used by a mobile equipment from a previous generation. But the UICC part of the UE does not change as much as the ME in a new generation of mobile network. Keeping a legacy UICC has the advantage that it saves the costs of UICC replacement for the mobile network operator. Thus, a scenario where the mobile user's UE has a new-generation mobile equipment ME and a legacy UICC was common in the past. Also in 5G mobile network, a UE comprising 5G mobile equipment and a legacy 4G UICC is a likely scenario. The advantage of the ME according to the first aspect is that it allows identity privacy of the mobile user to be enhanced in that scenario.

In a first possible implementation form of the mobile equipment according to the first aspect, the processor is configured to derive the temporary identifier by decrypting a secure channel based on the privacy key, the secure channel being encrypted and integrity protected based on the privacy key.

This possible implementation form has the advantage that the temporary identifiers can be derived even in places where there is no mobile network coverage, because the secure channel can be established over non-cellular access, e.g., WiFi link, or even a wired connection.

In a second possible implementation form of the mobile equipment according to the first aspect, the transceiver is configured to

receive a payload carrying Random Challenge, RAND, the payload carrying RAND comprising an encrypted temporary identifier, and wherein the payload comprises a flag indicating existence of the encrypted temporary identifier,

wherein the processor is configured to

identify the flag,

derive the temporary identifier by decrypting the encrypted temporary identifier based on the privacy key.

This possible implementation form has the advantage that it does not require ME to establish separate communication channel for receiving the encrypted temporary identifiers. The encrypted temporary identifier is embedded in RAND, which is part of the radio interface signaling.

In a third possible implementation form of the mobile equipment according to the first aspect or to the first aspect as such, the processor is configured to

derive a first temporary identifier and at least one second temporary identifier,
wherein the transceiver is configured to
transmit a first message comprising the first temporary identifier or the second temporary identifier for identifying the mobile equipment to a radio network.

This possible implementation form has the advantage that it is hard for an attacker to obtain long-term identity of the mobile user.

In a fourth possible implementation form of the mobile equipment according to the third implementation form of the first aspect, the first message comprises the first temporary identifier.

In a fifth possible implementation form of the mobile equipment according to the fourth implementation form of the first aspect, the transceiver is configured to

receive an error message in response to the transmission of the first message,

retransmit the first message comprising the first temporary identifier.

This possible implementation form enables the ME to deal with error situations in which the transmission of the first message has been corrupted.

In a sixth possible implementation form of the mobile equipment according to the fourth implementation form of the first aspect, the transceiver is configured to

receive an error message in response to the transmission of the first message, transmit at least one second message in response to the reception of the error message, the second message comprising the second temporary identifier or an IMSI for identifying the mobile equipment to the radio network.

This possible implementation form enables the ME to deal with error situations in which the transmission of the first message has been corrupted.

In a seventh possible implementation form of the mobile equipment according to the third implementation form of the first aspect, the first message comprises the second temporary identifier.

In an eighth possible implementation form of the mobile equipment according to the seventh implementation form of the first aspect, the transceiver is configured to

receive an error message in response to the transmission of the first message, transmit at least one second message in response to the reception of the error message, the second message comprising the first temporary identifier or the IMSI for identifying the mobile equipment to the radio network.

This possible implementation form enables the ME to deal with error situations in which the transmission of the first message has been corrupted.

In a ninth possible implementation form of the mobile equipment according to the sixth or eight implementation form of the first aspect, further comprising output means configured to, when the second message comprises the IMSI,

output information indicating use of the IMSI for identifying the mobile equipment to the radio network.

This possible implementation form enables ME to deal with error situations in which the transmission of the first message has been corrupted. This possible implementation form includes alerting the mobile user.

In a tenth possible implementation form of the mobile equipment according to the sixth or eight implementation form of the first aspect, the transceiver is configured to

receive an error message in response to the transmission of the second message,

retransmit at least the first message after a preset time period.

This possible implementation form enables the ME to deal with error situations in which the transmission of the second message has been corrupted.

In an eleventh possible implementation form of the mobile equipment according to the sixth or eight implementation form of the first aspect, further comprising output means, and wherein the second message comprises the first temporary identifier or the second temporary identifier,

wherein the transceiver is configured to

receive an error message in response to the transmission of the second message,

wherein the output means is configured to
output information indicating the error message.

This possible implementation form enables the ME to deal with error situations in which the transmission of the first or the second message has been corrupted. This possible implementation form includes alerting the mobile user.

In a twelfth possible implementation form of the mobile equipment according to any of the first to eleventh implementation forms of the first aspect, the processor is configured to

derive a new second temporary identifier,

discard the first temporary identifier,

set the second temporary identifier as the first temporary identifier,

set the new second temporary identifier as the second temporary identifier.

This possible implementation form enables the ME not to reuse past temporary identifiers.

In a further possible implementation form of the first aspect, at least one of the first message and the second message is an attach message.

In a further possible implementation form of the first aspect, the flag is in an Authentication and Management Field, AMF, of the payload carrying RAND.

In a further possible implementation form of the first aspect, the AMF is in an authentication token of the payload carrying RAND.

According to a second aspect of the invention, the above mentioned and other objectives are achieved with a user device comprising a mobile equipment according to any of the preceding claims, and a Universal Subscriber Identity Module, UICC,

wherein the UICC is configured to

provide the confidentiality key and the integrity key.

According to a third aspect of the invention, the above mentioned and other objectives are achieved with a network node for a wireless communication system, the network node comprising

a transceiver configured to
receive a request message for a mobile equipment,
a processor configured to

derive a privacy key for the mobile equipment,

encrypt at least one temporary identifier based on the privacy key,

wherein the transceiver is configured to

transmit the encrypted temporary identifier for the mobile equipment.

The network node according to the third aspect enables the handling of temporary identifiers in the ME according to the present solution.

In a first possible implementation form of the network node according to the third aspect, the processor configured to

provide a payload carrying RAND comprising an encrypted temporary identifier, the payload comprising a flag indicating the encrypted temporary identifier,

wherein the transceiver is configured to

transmit the payload carrying RAND for the mobile equipment in reply to the request message.

This possible implementation form has the advantage that it does not require separate communication channel for carrying the encrypted temporary identifiers to the ME.

In a second possible implementation form of the network node according to the third aspect, the transceiver is configured to

transmit at least one temporary identifier over a secure channel being encrypted and integrity protected based on the privacy key.

This possible implementation form has the advantage that the temporary identifiers can be transmitted to the ME even in places where there is no mobile network coverage, because the secure channel can be established over non-cellular access, e.g., WiFi link, or even a wired connection.

In a further possible implementation form of the third aspect, the request message comprises an IMSI for the mobile equipment.

According to a fourth aspect of the invention, the above mentioned and other objectives are achieved with a method comprising:

receiving at least one encoded temporary identifier,
obtaining a confidentiality key and an integrity key,
deriving a privacy key for the mobile equipment based on the confidentiality key and the integrity key,
deriving at least one temporary identifier based on the privacy key.

In a first possible implementation form of the method according to the fourth aspect, the method comprising

deriving the temporary identifier by decrypting a secure channel based on the privacy key, the secure channel being encrypted and integrity protected based on the privacy key.

In a second possible implementation form of the method according to the fourth aspect, the method comprising

receiving a payload carrying Random Challenge, RAND, the payload carrying RAND comprising an encrypted temporary identifier, and wherein the payload comprises a flag indicating existence of the encrypted temporary identifier,

identifying the flag,

deriving the temporary identifier by decrypting the encrypted temporary identifier based on the privacy key.

In a third possible implementation form of the method according to the fourth aspect or to the fourth aspect as such, the method comprising

deriving a first temporary identifier and at least one second temporary identifier,
transmitting a first message comprising the first temporary identifier or the second temporary
identifier for identifying the mobile equipment to a radio network.

In a fourth possible implementation form of the method according to the third implementation form of the fourth aspect, the first message comprises the first temporary identifier.

In a fifth possible implementation form of the method according to the fourth implementation form of the fourth aspect, the method comprising

receiving an error message in response to the transmission of the first message,

retransmitting the first message comprising the first temporary identifier.

In a sixth possible implementation form of the method according to the fourth implementation form of the fourth aspect, the method comprising

receiving an error message in response to the transmission of the first message, transmitting at least one second message in response to the reception of the error message, the second message comprising the second temporary identifier or an IMSI for identifying the mobile equipment to the radio network.

In a seventh possible implementation form of the method according to the third implementation form of the fourth aspect, the first message comprises the second temporary identifier.

In an eighth possible implementation form of the method according to the seventh implementation form of the fourth aspect, the method comprising

receiving an error message in response to the transmission of the first message, transmitting at least one second message in response to the reception of the error message, the second message comprising the first temporary identifier or the IMSI for identifying the mobile equipment to the radio network.

In a ninth possible implementation form of the method according to the sixth or eight implementation form of the fourth aspect, the method comprising, when the second message comprises the IMSI,

outputting information indicating use of the IMSI for identifying the mobile equipment to the radio network.

In a tenth possible implementation form of the method according to the sixth or eight implementation form of the fourth aspect, the method comprising

receiving an error message in response to the transmission of the second message,

retransmitting at least the first message after a preset time period.

In an eleventh possible implementation form of the method according to the sixth or eight implementation form of the fourth aspect, wherein the second message comprises the first temporary identifier or the second temporary identifier, the method comprising

receiving an error message in response to the transmission of the second message, outputting information indicating the error message.

In a twelfth possible implementation form of the method according to any of the third to eleventh implementation forms of the fourth aspect, the method comprising

deriving a new second temporary identifier,

discarding the first temporary identifier,

setting the second temporary identifier as the first temporary identifier,

setting the new second temporary identifier as the second temporary identifier.

According to a fifth aspect of the invention, the above mentioned and other objectives are achieved with a method comprising:

receiving a request message for a mobile equipment,

deriving a privacy key for the mobile equipment,

encrypting at least one temporary identifier based on the privacy key,

transmitting the encrypted temporary identifier for the mobile equipment.

In a first possible implementation form of the method according to the fifth aspect, the method comprising

providing a payload carrying RAND comprising an encrypted temporary identifier, the payload comprising a flag indicating the encrypted temporary identifier,

transmitting the payload carrying RAND for the mobile equipment in reply to the request message.

In a second possible implementation form of the method according to the fifth aspect, the method comprising

transmitting at least one temporary identifier over a secure channel being encrypted and integrity protected based on the privacy key.

The advantages of the method according to the fourth and the fifth aspects are the same as for the corresponding mobile equipment and network node according to the first and third aspect, respectively.

Embodiments of the invention also relates to a computer program, characterized in code means, which when run by processing means causes said processing means to execute any method according to the invention. Further, the invention also relates to a computer program product comprising a computer readable medium and said mentioned computer program, wherein said computer program is included in the computer readable medium, and comprises of one or more from the group: ROM (Read-Only Memory), PROM (Programmable ROM), EPROM (Erasable PROM), Flash memory, EEPROM (Electrically EPROM) and hard disk drive.

Further applications and advantages of the invention will be apparent from the following detailed description.

### BRIEF DESCRIPTION OF THE DRAWINGS

The appended drawings are intended to clarify and explain different embodiments of the invention, in which:

FIG. 1 shows a user device according to an embodiment of the invention;

FIG. 2 shows a corresponding method according to an embodiment of the invention;

FIG. 3 shows a network node according to a further embodiment of the invention;

FIG. 4 shows a corresponding method according to an embodiment of the invention;

FIG. 5 shows signaling aspects according to an exemplary embodiment of the invention;

FIG. 6 shows an exemplary part of a mobile user's record in the home network;

FIG. 7 shows an exemplary part of a mobile user's record in the home network;

FIG. 8 shows the derivation of a privacy key in a user device;

FIG. 9 shows signal between a mobile equipment and a network node.

### DETAILED DESCRIPTION

It is to be noted that the term “pseudonym” fully corresponds to the expression “temporary identifier” and are interchangeably used in the following disclosure. The pseudonym or temporary identifier is used by the ME for identifying the ME to a radio network of a wireless communication system. The pseudonyms/temporary identifiers are denoted by P and P′ in this disclosure. It is to be noted that further pseudonyms/temporary identifiers may be used which means that the present solution is not limited to two pseudonyms/temporary identifiers.

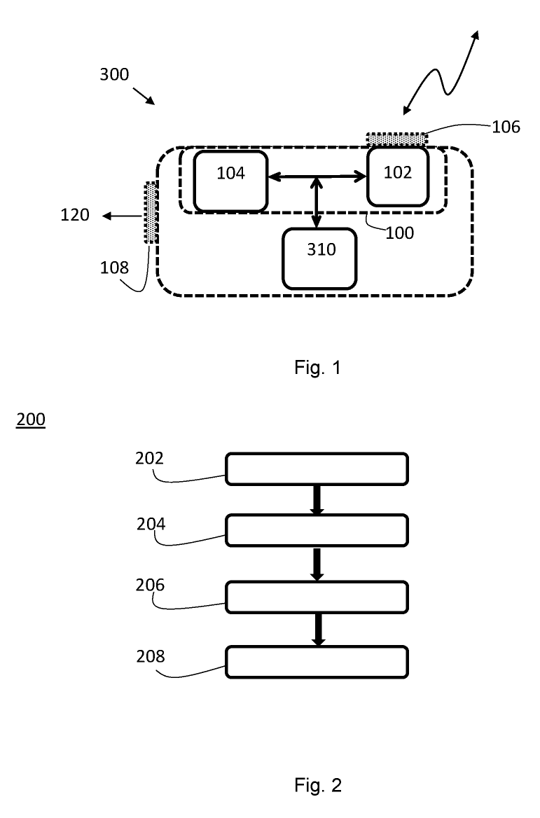

FIG. 1 shows an embodiment of a ME 100 according to the invention. FIG. 1 also shows the embodiment when the ME 100 is integrated in a user device 300 which in this case also comprises a Universal Subscriber Identity Module (UICC) 310. The user device 300 may e.g. be a UE. The ME 100 comprises a transceiver 102 which in this particular case is optionally coupled to receiving means 116 (such as an antenna for wireless communication) configured to receive wireless communication signals. The transceiver 102 is further coupled to a processor 104 of the ME 100. The transceiver 102 and the processor 104 are also communicably coupled to the UICC 310 in this particular embodiment. As aforementioned, a USIM is an application that runs inside the smart card, which is also called UICC 310. The operator-dependent data about the subscriber is stored in the USIM. This data includes the IMSI, which is the long-term identity of the subscriber; and the subscriber's master key K, which is shared with the home network.

According to the present solution, the transceiver 102 is configured to receive at least one encoded temporary identifier EP; EP′, and to obtain a confidentiality key CK and an integrity key IK. The processor 104 is configured to derive a privacy key Kp for the mobile equipment 100 based on the confidentiality key CK and the integrity key IK, and to derive at least one temporary identifier P; P′ based on the privacy key Kp.

FIG. 2 shows a corresponding method 200 which may be implemented in a ME 100, such as the one shown in FIG. 1. The method 200 comprises the step of receiving 202 at least one encoded temporary identifier EP; EP′. The method 200 further comprises the step of obtaining 204 a confidentiality key CK and an integrity key IK. The method 200 further comprises the step of deriving 206 a privacy key Kp for the mobile equipment 100 based on the confidentiality key CK and the integrity key IK. The method 200 further comprises the step of deriving 208 at least one temporary identifier P; P′ based on the privacy key Kp.

In an embodiment, the ME 100 further comprises optional output means 108 as shown in FIG. 1. The output means may be any suitable means for outputting information to the user (not shown) of the ME 100. The information may be visual, audio, tactile, etc. The output means 108 is according to the present solution configured to output information 120 indicating use of the IMSI for identifying the ME 100 to the radio network or for indicating reception of an error message. Thereby, the user of the ME 100 is informed of any of the mentioned cases.

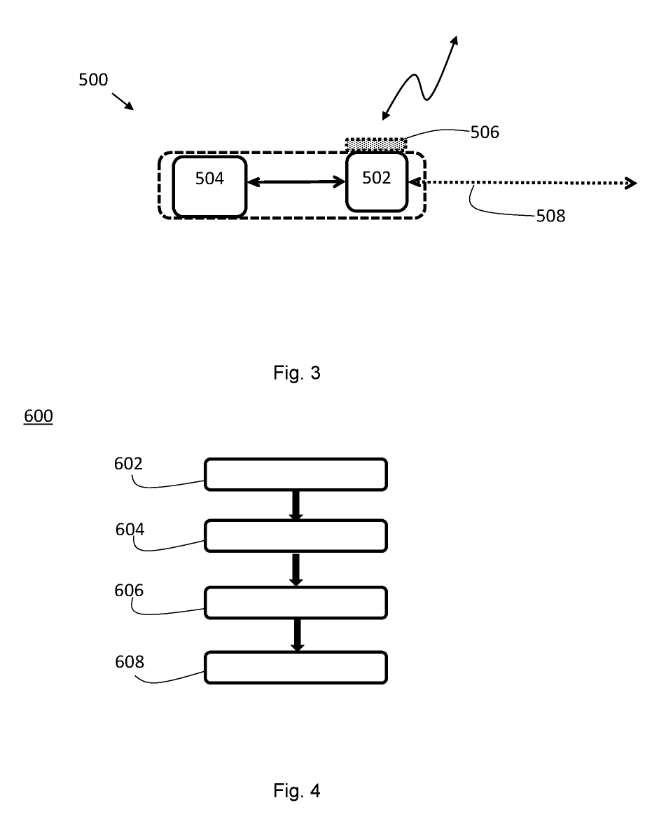

FIG. 3 shows a network node 500 according to an embodiment of the invention. The network node 500 comprises a transceiver 502 which in this particular case is optionally coupled to receiving means 506 (such as an antenna for wireless communication) configured to receive and transmit wireless communication signals. The network node 500 may also optionally comprise a modem 508 configured to receive and transmit wired communication signals.

According to the present solution, the transceiver 502 is configured to receive a request message for a mobile equipment 100. The processor 504 is configured to derive a privacy key Kp for the mobile equipment 100, and to encrypt at least one temporary identifier P; P′ based on the privacy key Kp. The transceiver 502 is configured to transmit the encrypted temporary identifier P; P′ for the mobile equipment 100.

FIG. 4 shows a corresponding method 400 which may be implemented in a network node 300, such as the one shown in FIG. 3. The method 400 comprises the step of receiving 402 a request message for a mobile equipment 100. The method 400 further comprises the step of deriving 404 a privacy key Kp for the mobile equipment 100, The method 400 further comprises the step of encrypting 406 at least one temporary identifier P; P′ based on the privacy key Kp. The method 400 further comprises the step of transmitting 408 the encrypted temporary identifier P; P′ for the mobile equipment 100.

In an embodiment, the temporary identifiers P, P′ have the same format as IMSI. Hence, there is a non-changing part pointing to the correct home network, and a changing part that is in the form of MSIN. Thus, the length of the changing part is 9-10 decimal digits, which can be encoded in less than 40 bits.

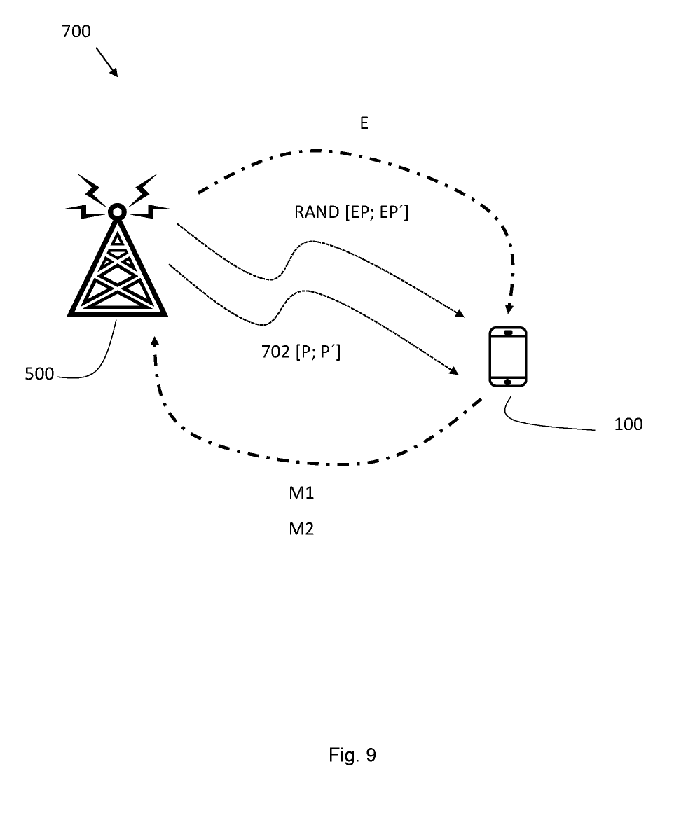

In an embodiment, the processor 104 of the ME 100 is configured to derive the temporary identifier P; P′ by decrypting a secure channel 702 based on the privacy key Kp. The secure channel 702 is encrypted and integrity protected based on the privacy key Kp. This is illustrated in FIG. 9 in which the ME 100 receives the temporary identifier P; P′ from the network node 500 over the secure channel 702. Correspondingly, the transceiver 502 of the network node 500 is configured to transmit at least one temporary identifier P; P′ over a secure channel 702. The secure channel 702 is encrypted and integrity protected based on the privacy key Kp.

In another embodiment, the transceiver 102 of the ME 100 is configured to receive a payload carrying Random Challenge (RAND). The payload carrying RAND comprises at least one encrypted temporary identifier EP; EP′. Further, the payload comprises a flag indicating existence of the encrypted temporary identifier EP; EP′. The processor 104 is configured to identify the flag, and to derive the temporary identifier P; P′ by decrypting the encrypted temporary identifier EP; EP′ based on the privacy key Kp. This is also illustrated in FIG. 9 in which the ME 100 receives the payload carrying RAND from the network node 500. Accordingly, the processor 504 of the network node 500 is configured to provide a payload carrying RAND comprising at least one encrypted temporary identifier EP; EP′. The payload of the RAND comprises a flag indicating the encrypted temporary identifier EP; EP′. The transceiver 502 is configured to transmit the payload carrying RAND for the ME 100 in reply to a request message. In an embodiment the request message comprises the IMSI for the ME 100.

It is to be noted that the communication between the network node 500 and the ME 100 may be over one or more intermediate communication nodes.

In yet another embodiment, the processor 104 of the ME 100 is configured to derive a first temporary identifier P and at least one second temporary identifier P′. The transceiver 102 is further configured to transmit a first message M1 comprising the first temporary identifier P or the second temporary identifier P′ for identifying the mobile equipment 100 to a radio network. This is illustrated in FIG. 9 in which the ME 100 transmits the first message M1.

The derivation of the privacy key Kp by the ME 100 is illustrated in FIG. 8. Like KASME, the privacy key Kp is derived from a ciphering key CK, an integrity key IK and Service Network ID, SN ID. The difference is that while KASME is sent to the serving network from the home network, the privacy key Kp is not sent to the serving network from the home network. The USIM running in the UICC 310 derives the ciphering key CK and the integrity key IK and gives them to the ME 100. A cryptographic Key Derivation Function (KDF) is used to derive KASME from CK, IK and SN ID. All cryptographic keys that are needed for various security mechanisms between the ME 100 and the serving network are then derived from KASME. The KDF has the property that it is impossible in practice to compute its inputs from the output KASME. In LTE the KDFs use the generic KDF that is specified in 3GPP TS 33.220. In this generic KDF the core cryptographic primitive is the HMAC-SHA-256 algorithm (Keyed-Hash Message Authentication Code-Secure Hash Algorithm).

In an embodiment, a flag in the Authentication Management Field (AMF) of authentication token AUTN is used in the ME 100 to distinguish between normal RAND and the special payload carrying RAND that includes the encrypted pseudonym EP, EP′.

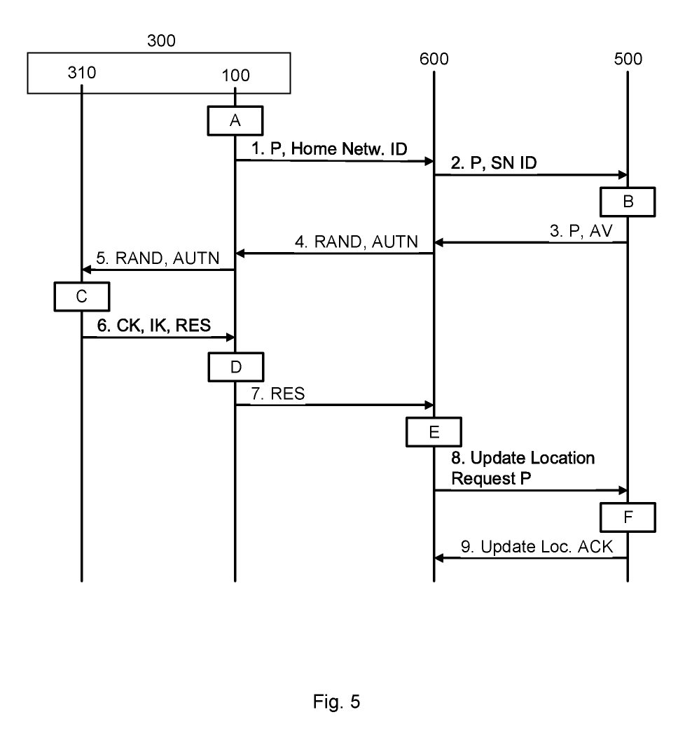

Furthermore, FIG. 5 shows a message flow chart of an exemplary embodiment of the invention. The exemplary embodiment is set in a 3GPP system context, hence the terminology and system assumptions used. For example, a user device 300 in this case corresponds to a UE and a network node 500 to a Home Subscriber Server (HSS). However, the skilled person realizes that embodiments of the invention are not limited thereof.

Further, in this particular example a network node 600 of a serving network interoperates with the UE 300 (the UE 300 comprises a ME 100 and a UICC 310) and the network node 500 of the home network. Therefore, when the expression “serving network” is used this expression can also be read as “network node 600 of the serving network” and when the expression “home network” is used this expression can also be read as “network node 300 of the home network”.

Further, the present solution is also applicable to the case when the serving network is the same as the home network which is readily realized by the skilled person.

At 1)

The unauthenticated UE 100 (comprising a ME 100 and a UICC 310) sends one of its temporary identities, i.e. the first pseudonym P or the second pseudonym P′ and the identity of the home network 500 to the serving network 600 over the radio interface. Before that happens, the ME 100 part of the UE 300 decides which identity to use. That decision is encapsulated in box A.

Box A

Before describing the pseudonym choice in the ME 100 according to embodiments of the invention, let us recap how the current, e.g., LTE, ME 100 behaves in this respect:

On first Attach (connect) to a new serving network the ME 100 uses IMSI;
After AKA and security setup it receives a temporary identifier TMSI (in encrypted message) from the serving network;
As long as the ME 100 stays attached to the serving network it uses TMSI in subsequent communications with that serving network;
If TMSI does not work, then ME 100 falls back on using its IMSI.

Now we continue with describing the pseudonym choice in the ME 100 according to the present solution.

First, a ME 100 that has never before got a pseudonym P from the home network 500, uses its IMSI (which it gets from the USIM) on its first Attach to the serving network 600 (for instance, this could be a new, “out of the box” ME). After a successful Attach operation, the ME 100 gets its first pseudonym P and second pseudonym P′ from the home network 500. As described earlier, two options for getting the pseudonym are: via dedicated secure channel, or inside special payload carrying RAND.

Second, after the ME 100 has got a pseudonym P from the home network 500 the ME 100 performs the following operations:

On first Attach (connect) to a new serving network using first pseudonym P.
After AKA and security setup, receiving TMSI (in encrypted message) from the serving network. This operation, which happens after successful validation of RES in box E is not shown in FIG. 5.

After a successful Attach operation the ME 100 gets a second pseudonym P′ from the home network.

As long as the ME 100 stays attached to the serving network the ME 100 uses TMSI in subsequent communications with the serving network.

If TMSI does not work, the ME 100 falls back on using the first pseudonym P.

On next Attach to a serving network the ME will use the second pseudonym P′.

The above behavior could be built into the ME 100. But if the second pseudonym P′ does not work, the ME 100 could use either the first pseudonym P or the second pseudonym P′ for the next try. We will now describe three different options of the pseudonym usage policy in the ME 100. However, the present solution is not limited thereof and is therefore applicable in many more policies.

Policy 1—Never go back to previously used the first pseudonym P. If the second pseudonym P′ does not work in several attempts and after some significant time period, inform the user. If user gives permission: send IMSI in the Attach request; otherwise, the user has to go to operator's office to recover.

Policy 2—First try again the second pseudonym P′, but after some (short) time period switch to trying previously used first pseudonym P. If neither the first pseudonym P nor the second pseudonym P′ work, try both again after some significant time period. If these still do not work, inform the user. If user gives permission: send IMSI; otherwise, the user has to go to operator's office to recover.

Policy 3—First try first pseudonym P (i.e. go back to the previously used pseudonym), but if that does not work act as in policy 2, i.e. try the second pseudonym P′ and if it still does not work, then try the first pseudonym P again.

The ME 100 could in an embodiment get the policy, including parameters stating how long are “short” and “significant” times, from the mobile network operator. This could be done either via the USIM, or via a secure channel from operator's server to the ME 100. For example, the policy could be preinstalled in the ME 100 by the operator. In another example, the same way as the one used in providing the next pseudonym could be used also in provisioning and updating the pseudonym usage policy to the ME 100. It is noted however, that it is expected that the policy changes less frequently than pseudonyms.

It is noted also that different policies may have varying vulnerability to attacks by a malicious party against a ME 100 which uses pseudonyms according to the invention. As an example, consider two such attacks:

Denial of Service (DoS) attack by forcing the ME 100 to run out of valid pseudonyms.

Linkability attack. The target of the attacker is to find both the current pseudonym, and the previous pseudonym of the ME 100; i.e., the attacker tries to find out valid identifier (P, P′) pairs of the ME 100.

The above Policy 1 is vulnerable to DoS attacks; but provides full protection against linkability attacks. Policies 2 and 3 above are vulnerable to linkability attacks, but less vulnerable to DoS attacks.

At 2)

The serving network 600 forwards the first pseudonym P and the SN ID to the home network 500, e.g., in an Authentication Information Request message.

Box B

The home network 500 finds based on the first pseudonym P, the IMSI of the ME 100 and the master key K of the subscriber. Then it computes the Authentication Vector (AV), chooses the second pseudonym P′ for the ME 100 (if it has not done so already) and encrypts the second pseudonym P′ with the privacy key Kp that it derived from the master key K. We will describe these operations in more detail.

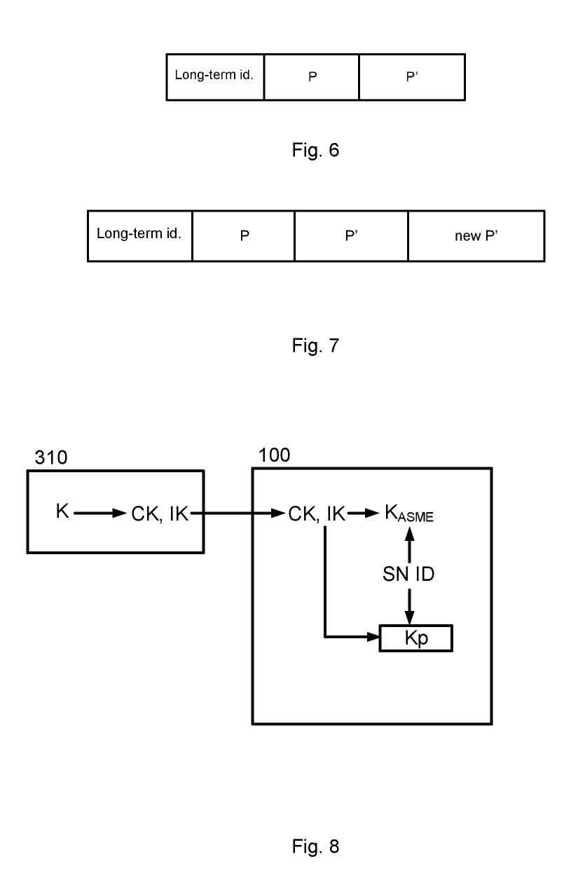

Upon receiving message 2, e.g., Authentication Information Request message for long-term ID (IMSI) from the serving network 600, the home network 500 embeds the first pseudonym P into RANDs of the AV (if it has not already done so), and sends the AV to the serving network 600 in message 3, e.g., in an Authentication Information Answer message. For example, if in the first Attach the UE 300 uses its long term ID (IMSI); it will then receive first pseudonym P. Upon receiving message 2, e.g., Authentication Information Request message, for the first pseudonym P from the serving network 600, the home network 500 embeds the second pseudonym P′ into RANDs of the AV (if it has not already done so), and sends the AV to the serving network 600 in message 3, e.g., Authentication Information Answer message. In this situation part of subscriber's record in the home network 500 may look as illustrated in FIG. 6. The record will include P and P′ in addition to long-term identity of the subscriber.

Upon receiving message 2 for the second pseudonym P′, the home network 500 does the following:

Allocates new second pseudonym Pnew′ to the subscriber (if it has not already done so);

Embeds new second pseudonym Pnew′ into RANDs of the AV (if it has not already done so), and sends the AV to the serving network 600 in message 3. In this situation part of subscriber's record in the home network 500 may look as illustrated in FIG. 7. The record will include P, P′ and Pnew′ in addition to long-term identity of the subscriber.

At 3)

The home network 500 sends a first pseudonym P, the AV and the encrypted second pseudonym P′ to the serving network 600.

At 4)

The serving network 600 starts the cellular AKA procedure with the UE 300 using the received AV. The serving network 600 takes RAND authentication token AUTN and the expected response XRES to RAND from AV, and sends the RAND and AUTN to the UE 300, e.g., in an Authentication Request message.

At 5)

The ME 100 forwards the pair RAND and AUTN to the USIM.

Box C

The USIM checks if the pair RAND and AUTN is valid. If the pair passes the check, the USIM derives the keys CK, IK and computes the response RES.

At 6)

The USIM returns CK, IK and the response RES to ME 100.

Box D

The ME 100 derives KASME. A flag in the Authentication Management Field (AMF) of AUTN is used in the ME 100 to distinguish between a normal RAND and a special payload carrying RAND that includes the encryption EP′ of next pseudonym P′. The ME 100 checks from the AMF of AUTN if the RAND comprises an embedded second pseudonym P′. If yes, the ME 100 derives a privacy key Kp, decrypts the second pseudonym P′ and updates its internal list of pseudonyms.

At 7)

The ME 100 sends the response RES to the serving network 600.

Box E

The serving network 600 compares the response RES with the expected response (XRES) which is part of the authentication vector AV. When they match, the authentication of the UE 300 has been successful.

At 8)

After successful authentication the serving network sends message 8, e.g., Update Location Request message for identity the first pseudonym P to the home network 500.

Box F

The home network 500 updates the identifiers in subscriber record which will be described in more detail.

Upon receiving message 8, e.g., Update Location Request message for the second pseudonym P′ from the serving network 600, the home network 500:

Allocate a new second pseudonym Pnew′ to the subscriber (if it has not already done so).

Release/Discard the first pseudonym P.

Set the second pseudonym P′=first pseudonym P.

Set the new second pseudonym Pnew′=second pseudonym P′.

After these operations the subscriber's record may look again like illustrated in FIG. 6.

In order to be able to associate Charging Data Records (CDRs) produced by the serving network 600 with the correct long-term ID of the user, the home network 500 needs to remember the first pseudonym P used by the UE 300 for some time after the first pseudonym P has been released. For that reason, each pseudonym that a UE 300 has used, together with its allocation time T1 to that UE 300 and also its release time T2, will be stored in the home network 500 for some time after T2.

At 9)

Finally, the home network 500 acknowledges reception of message 8 Update Location Request to the serving network 600.

Furthermore, any methods according to embodiments of the invention may be implemented in a computer program, having code means, which when run by processing means causes the processing means to execute the steps of the method. The computer program is included in a computer readable medium of a computer program product. The computer readable medium may comprises of essentially any memory, such as a ROM (Read-Only Memory), a PROM (Programmable Read-Only Memory), an EPROM (Erasable PROM), a Flash memory, an EEPROM (Electrically Erasable PROM), or a hard disk drive.

Moreover, it is realized by the skilled person that the ME 100 and the network node 500 comprise the necessary communication capabilities in the form of e.g., functions, means, units, elements, etc., for performing the present solution. Examples of other such means, units, elements and functions are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, MSDs, TCM encoder, TCM decoder, power supply units, power feeders, communication interfaces, communication protocols, etc. which are suitably arranged together for performing the present solution.

Especially, the processors of may comprise, e.g., one or more instances of a Central Processing Unit (CPU), a processing unit, a processing circuit, a processor, an Application Specific Integrated Circuit (ASIC), a microprocessor, or other processing logic that may interpret and execute instructions. The expression “processor” may thus represent a processing circuitry comprising a plurality of processing circuits, such as, e.g., any, some or all of the ones mentioned above. The processing circuitry may further perform data processing functions for inputting, outputting, and processing of data comprising data buffering and device control functions, such as call processing control, user interface control, or the like.

Finally, it should be understood that the invention is not limited to the embodiments described above, but also relates to and incorporates all embodiments within the scope of the appended independent claims.

1. Mobile equipment for a wireless communication system, the mobile equipment comprising:
a transceiver, the transceiver configured to:
receive at least one encoded temporary identifier; and
obtain a confidentiality key and an integrity key; and
at least one processor, the at least one processor configured to:
derive a privacy key for the mobile equipment based on the confidentiality key and the integrity key; and
derive at least one temporary identifier based on the privacy key.

2. The mobile equipment according to claim 1, wherein the at least one processor is configured to derive the at least one temporary identifier by decrypting a secure channel based on the privacy key, wherein the secure channel is encrypted and integrity protected based on the privacy key.

3. The mobile equipment according to claim 1, wherein:
the transceiver is configured to receive a payload carrying a Random Challenge (RAND), wherein the payload carrying the RAND comprises an encrypted temporary identifier, and wherein the payload comprises a flag indicating existence of the encrypted temporary identifier; and
the at least one processor is configured to:
identify the flag; and
derive the temporary identifier by decrypting the encrypted temporary identifier based on the privacy key.

4. The mobile equipment according to claim 1, wherein:
the at least one processor is configured to derive a first temporary identifier and at least one second temporary identifier; and
the transceiver is configured to transmit a first message comprising the first temporary identifier or the second temporary identifier for identifying the mobile equipment to a radio network.

5. The mobile equipment according to claim 4, wherein the first message comprises the first temporary identifier.

6. The mobile equipment according to claim 5, wherein the transceiver is configured to:
receive an error message in response to the transmission of the first message; and
retransmit the first message comprising the first temporary identifier.

7. The mobile equipment according to claim 5, wherein the transceiver is configured to:
receive an error message in response to the transmission of the first message; and
transmit at least one second message in response to the reception of the error message, wherein the second message comprises at least one of the second temporary identifier or an IMSI for identifying the mobile equipment to the radio network.

8. The mobile equipment according to claim 7, further comprising output means configured to, when the second message comprises the IMSI:
output information indicating use of the IMSI for identifying the mobile equipment to the radio network.

9. The mobile equipment according to claim 7, wherein the transceiver is configured to:
receive an error message in response to the transmission of the second message; and
retransmit at least the first message after a preset time period.

10. The mobile equipment according to claim 7, further comprising output means, wherein:
the second message comprises the first temporary identifier or the second temporary identifier;
the transceiver is configured to receive an error message in response to the transmission of the second message; and
the output means is configured to output information indicating the error message.

11. The mobile equipment according to claim 4, wherein the first message comprises the second temporary identifier.

12. The mobile equipment according to claim 11, wherein the transceiver is configured to:
receive an error message in response to the transmission of the first message; and
transmit at least one second message in response to the reception of the error message, wherein the second message comprises at least one of the first temporary identifier or the IMSI for identifying the mobile equipment to the radio network.

13. The mobile equipment according to claim 4, wherein the at least one processor is configured to:
derive a new second temporary identifier;
discard the first temporary identifier;
set the second temporary identifier as the first temporary identifier; and
set the new second temporary identifier as the second temporary identifier.

14. A network node for a wireless communication system, the network node comprising:
a transceiver, the transceiver configured to receive a request message for a mobile equipment; and
at least one processor configured to:
derive a privacy key for the mobile equipment; and
encrypt at least one temporary identifier based on the privacy key; and
wherein the transceiver is configured to transmit the encrypted temporary identifier for the mobile equipment.

15. The network node according to claim 14, wherein:
the at least one processor is configured to provide a payload carrying a Random Challenge (RAND) comprising an encrypted temporary identifier, wherein the payload comprises a flag indicating the encrypted temporary identifier; and
the transceiver is configured to transmit the payload carrying the RAND for the mobile equipment in reply to the request message.

16. The network node according to claim 14, wherein the transceiver is configured to transmit at least one temporary identifier over a secure channel being encrypted and integrity protected based on the privacy key.

17. A method performed at a mobile equipment, the method comprising:
receiving at least one encoded temporary identifier;
obtaining a confidentiality key and an integrity key;
deriving a privacy key for the mobile equipment based on the confidentiality key and the integrity key; and
deriving at least one temporary identifier based on the privacy key.

18. A method comprising:
receiving a request message for a mobile equipment;
deriving a privacy key for the mobile equipment;
encrypting at least one temporary identifier based on the privacy key; and
transmitting the encrypted temporary identifier for the mobile equipment.
